(19) United States
(12) Patent Application Publication
(10) Pub. No.: US 2007/0142959 A1
(43) Pub. Date: Jun. 21, 2007

(54) Food product slicer with automatic indication of when to sharpen knife

(76) Inventors: Samuel A. Rummel, Pooler, GA (US); Shahram Shariff, Savannah, GA (US)

Correspondence Address: THOMPSON HINE LLP, P.O Box 8801, DAYTON, OH, 45401-8801, US

(21) Appl. No.: 11/311,061

(22) Filed: Dec. 19, 2005

(51) Int. Cl. G06F 19/00

(52) U.S. Cl. 700/160; 83/174

(57) ABSTRACT

A food product slicer with a rotatable slicer knife includes a knife sharpener and a control for indicating when the slicer knife should be sharpened.

### TECHNICAL FIELD

This application relates generally to food product slicers used for slicing bulk food products and, more specifically, to a food product slicer including a control for determining when to sharpen the slicer knife.

### BACKGROUND

Food product slicers having circular slicer knives are commonly used in restaurant and grocery businesses, among others. The use of slicer mounted knife sharpening assemblies to sharpen the peripheral edge of the slicer knife when necessary is also known. Many operators have difficulty determining when the slicer knife needs to be sharpened. The nature and extent of use of the slicer can vary widely, making the determination even more difficult. It would be desirable to provide a food product slicer that incorporates a feature that automatically identifies when the slicer knife should be sharpened.

### SUMMARY

In one aspect, a food product slicer includes a slicer body and a slicer knife mounted for rotation relative to the slicer body. The slicer knife has a peripheral cutting edge. A food product carriage is mounted to the slicer body for reciprocating movement back and forth past a cutting zone of the slicer knife. A control is operable to track a count of a selected knife use characteristic of the slicer. The control is operable to effect production of a knife sharpen signal based at least in part upon the count.

In another aspect, a method is provided for identifying when to sharpen a circular slicer knife of a slicer having a food product carriage mounted for reciprocating movement back and forth past a cutting zone of the slicer knife. The method includes the steps of: tracking a count of a selected knife use characteristic of the slicer; comparing the tracked count with a set count; and producing a knife sharpen signal based at least in part upon the comparison.

### BRIEF DESCRIPTION OF THE DRAWINGS

FIG. 1 is a side elevation of a food product slicer;

FIG. 2 is a partial cross-section of a manual knife sharpener assembly;

FIG. 3 is a partial cross-section of a powered knife sharpener assembly;

FIG. 4 is a block diagram of a slicer control arrangement.

### DETAILED DESCRIPTION

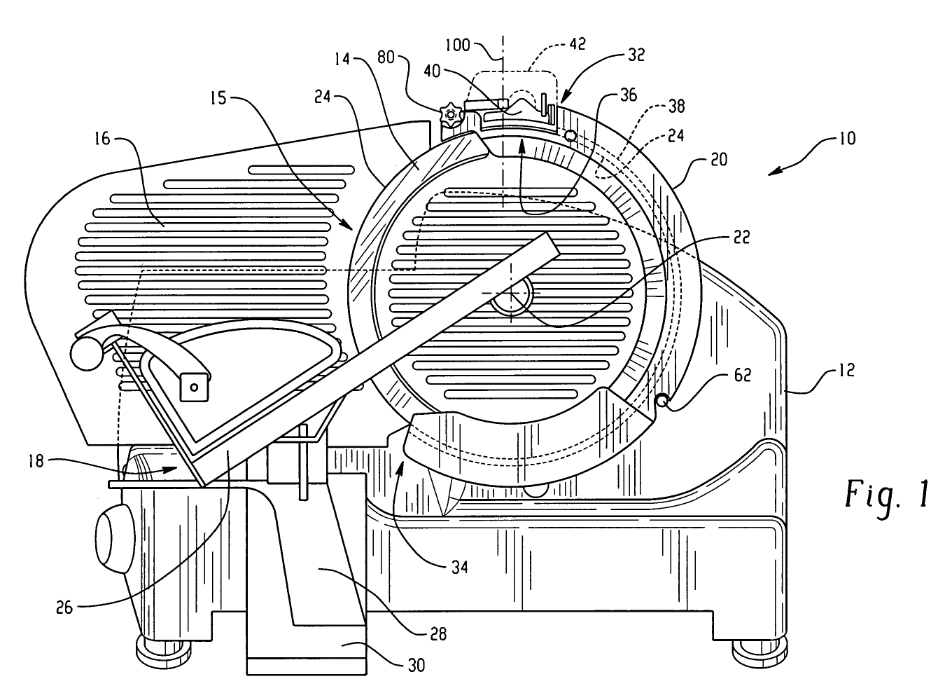

Referring to FIG. 1, a food slicing machine 10 includes housing 12 that, with other components such as an internal casting form part of the slicer body (often times also referred to as a base). Slicing machine 10 also includes a circular slicing knife 14, gauge plate 16, product supporting carriage 18 and a cover plate 20. The circular slicing knife 14 is mounted to the slicer body for rotation about an axis 22 by a motor or other drive (not shown). A peripheral cutting edge 24 of the knife is exposed in a cutting region 15 of the knife that is proximate the gauge plate 16 (e.g., generally extending from approximately a seven o'clock position to an eleven o'clock position in the illustrated embodiment, with other variations possible). The gauge plate is movable transversely with respect to a plane defined by the peripheral edge 24 of the knife to control slice thickness, and can be located in a “zero” position wherein it is slightly raised above the cutting zone of the peripheral edge 24. The food product carriage 18 includes tray 26 mounted on support arm 28, which in turn may be pivotally mounted to a transport 30 that extends into the housing. The transport 30 is supported internal of the housing for linear, reciprocating movement back and forth past the slicer knife 14 in any suitable manner, variations of which are known in the art. Carriage movement may be implemented manually or automatically (e.g., as by a drive motor and belt system, by hydraulics or by other means). As food product is moved past the cutting edge of the knife in a slicing stroke, the food product on the tray 26 slides across the outwardly facing surface of the cover plate 20, which surface may be formed with raised ridges to improve slidability.

The illustrated cover plate 20 covers the peripheral cutting edge 24 of the slicer knife 14 from about a one o'clock position 32 to about a seven o'clock position 34. The peripheral cutting edge 24 is shown in shadow beneath the cover plate 20. In a twelve o'clock region 36 of the slicer knife 14, the cover plate diameter decreases to provide a space or opening at which the edge of knife can be sharpened. The cover plate 20 also extends over a ring guard 38 (only inner edge shown in shadow in FIG. 1) that is disposed about the peripheral cutting edge along at least a portion of the non-cutting zone of the circular slice knife, leaving a gap between ring guard and the peripheral cutting edge as shown. The ring guard may be fixed to the housing 12 in a stationary manner, or may be fixed to the housing to permit some movement for cleaning as described in U.S. Pat. No. 5,509,337. In either case, the ring guard is positioned to protect the cutting edge 24 of the slicing knife 14. In the illustrated embodiment, the ring guard 38 does not extend into the twelve o'clock zone 36 of the slicer knife, but such zone is provided with a knife guard member 40 that moves to permit sharpening by a sharpener assembly 42 (shown only in outline in FIG. 1). For example, knife guard member 40 may pivot about an axis 100 during sharpening. A small gap is provided between the knife guard member 40 and the peripheral edge 24 of the knife as shown.

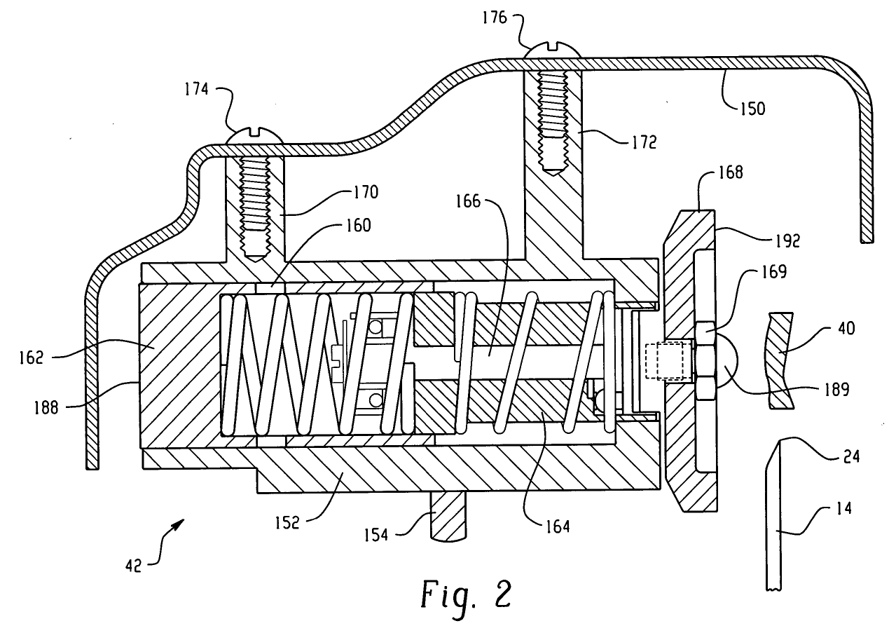

The configuration of the sharpening assembly 42 provided in connection with a given slicer can vary widely. Referring now to FIG. 2, a sharpener assembly similar to that described in U.S. Pat. No. 5,591,072 is shown. A cover 150 is coupled to a stationary block member 152. A mounting post 154 extends from the bottom of block member 152 and may include outwardly projecting pins (not shown) for positioning in the side slots of a mount opening (not shown) that may be formed in a mount arm (not shown) of the slicer body. The block member 152 includes a through passage or cavity 160 extending from end to end thereof and in which an actuator body 162 is slidably positioned for engaging a plunger assembly 164. The actuator body and plunger assembly operate substantially as described in U.S. Pat. No. 5,591,072 such that when actuator body 162 is moved toward the knife (e.g., to the right in FIG. 2), the springs of the plunger assembly 164 are compressed and the shaft 166 is moved toward the knife 14 so as to move the sharpening stone, in the form of wheel 168, toward the knife 14 into a sharpening position in contact with the edge 24 of the knife 14. A stone retaining screw or bolt 169 is provided to hold the sharpening wheel 168 in place while at the same time allowing it to rotate. Alternatively, a screw may extend outward from within the block member 152 and member 169 may be a nut threaded onto the screw. As shown, the top of block member 152 includes mount posts 170, 172 for receiving fasteners 174, 176 to mount the cover 150 to the block member 152.

In one embodiment, an actuating handle or lever (not shown) may be provided for contacting the rear side 188 of the block member 152 to push the block member toward the knife 14 and move the sharpening wheel 168 from its standby position, which is the position shown in FIG. 2, to a sharpening position. As seen, when the stone 168 is moved toward the knife 14, the head 189 of the bolt 169 will contact the side of the knife guard member 40 prior to the working surface 192 of the stone 168 contacting the knife 14, which will pivot the knife guard member out of the cutting edge guarding position and into the cutting edge sharpening position. The sharpening assembly may also include a truing stone (not shown) that pivots to the right side of the knife 14 (as viewed in FIG. 2) when the actuator body 162 is moved to the right to its fullest extent, as is generally shown and described in U.S. Pat. No. 5,591,072. An interlock (not shown) may be provided in connection with the knife guard member 40 to hold the knife guard member in its cutting edge guarding position, in which the sharpener assembly 42 may include an interlock actuator (not shown) for automatically disabling the interlock during a sharpening operation, to permit the knife guard member to move to its cutting edge sharpening position. A solenoid or other powered actuator (e.g., motor drive, pneumatic actuator or linear actuator) may also be provided for moving the knife guard member 40. Alternatively, as shown in U.S. Pat. No. 4,817,480, the sharpener may be associated with the carriage when needed for sharpening.

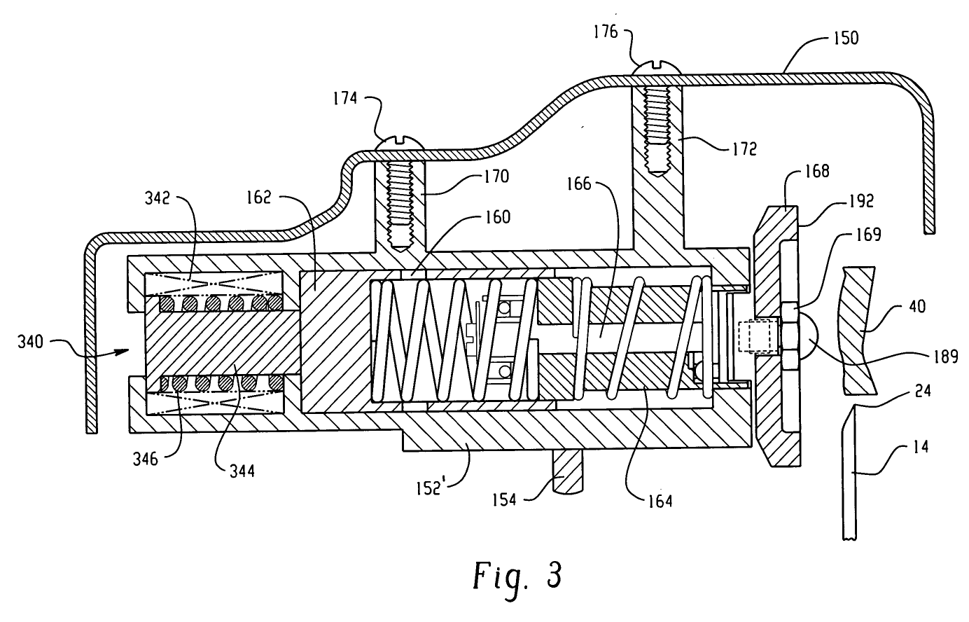

Referring to FIG. 3, an alternative embodiment of the sharpener assembly is shown in which a solenoid 340 is positioned at the end of an elongated block member 152′. The solenoid 340 includes a coil 342 that, when energized, moves plunger 344 to the right for moving the actuator body 162. A spring 346 biases the plunger 344 into the illustrated position. Thus, the FIG. 3 embodiment provides for automated sharpening (e.g., by pressing an input button that causes energization of the solenoid 340). The solenoid 340 may be energized for a set period of time such that sharpening takes place for a set period of time (e.g., such as in a range of 4 to 8 seconds, or whatever time period may be determined appropriate based upon testing). This feature assures adequate sharpening and a that same time avoids excessive sharpening that can wear the knife more quickly than desired. A similar feature could be implemented using other types of powered sharpeners. Moreover, a manually actuated sharpener could be modified to include a mechanically implemented timeout feature by which the sharpening time period could be controlled or set to be within a desired range.

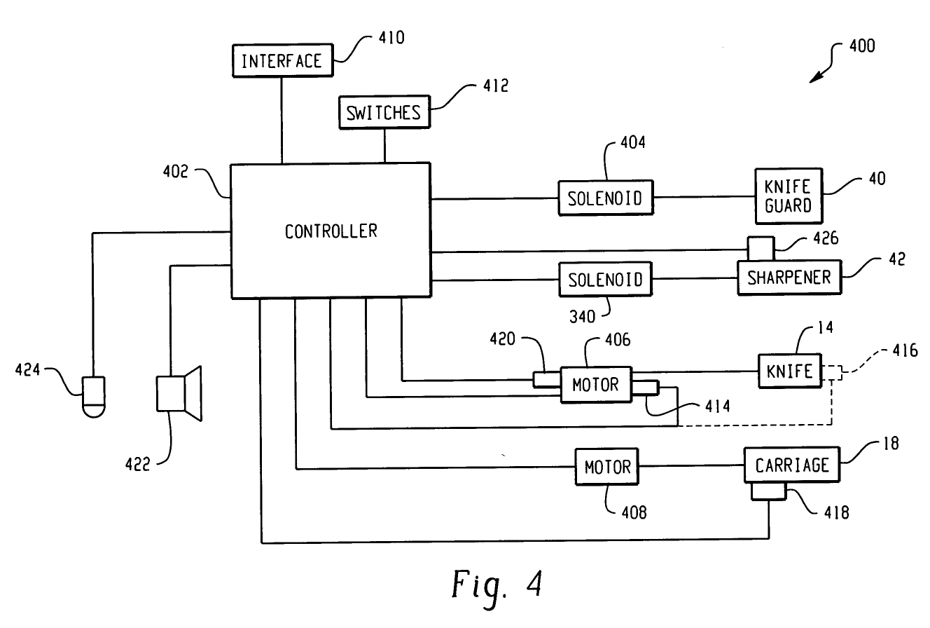

Referring to FIG. 4, an exemplary slicer control system diagram 400 is shown. A controller 402 (which may include a processor and memory, such as flash memory) is connected with a solenoid 404 that may be provided for moving the knife guard member 40. Alternatively, solenoid 404 could be eliminated where the knife guard member 40 is manually movable as described above. Controller 402 is also connected with solenoid 340 associated with the sharpener assembly 42 (FIG. 3 embodiment). Where the sharpener assembly 42 is manual, solenoid 340 may be eliminated. Controller 402 is connected with a knife drive in the form of motor 406, and is also connected with a carriage drive in the form of motor 408. The carriage 18 may be selectively uncoupled from motor 408 to also permit manual movement of the carriage. Controller 402 is also connected with a user interface display 410 and with a user input in the form of one or more input keys or switches 412. If the display 410 is of the touch sensitive type, the display may function as a user input in addition to or in place of user input 412. A motor encoder 414 provides feedback to the controller 402, from which the controller can determine knife rotations if needed. Alternatively, an encoder or other sensor 416 may be associated with the knife 14 itself to track knife rotation. A sensor 418 provides feedback to the controller 402 regarding carriage position and/or movement. Sensor 418 may be as simple as an end of stroke switch or may take the form a more complex encoder arrangement. Different types of sensors, mechanical, optical or magnetic may also be sued. A motor load sensor 420 may also be provided for the knife motor 406. A control system such as that illustrated may be configured to automatically determine when to sharpen the slicer knife in any one of a variety of techniques, as will now be described.

In one technique, the controller 402 tracks a count of slicing strokes of the food product carriage 18, based upon the feedback from sensor 418, in order to determine when to sharpen the knife. Specifically, based upon knife testing it can be determined that, on average, a slicer knife needs to be sharpened after a given number of slicing strokes. The controller tracks the count of slicing strokes and when the count exceeds the given number, the controller outputs a knife sharpen signal (e.g., causing a buzzer or other audio annunciator 422 to output a sound, causing an LED or other visual annunciator 424 to output a visual signal and/or causing a sharpen message to be displayed on the display 410). Where the sharpener is manual, the slicer operator can then initiate a manual sharpening operation and actuate the user input 412 to reset the slicing stroke count once sharpening is completed. Alternatively, a sharpen sensor 426 could be mounted on the sharpener 42 to trigger a feedback to the controller 402 upon sharpening (e.g., after the sharpening wheel 168 has been fully extended for some minimum period of time).

Where the sharpener is automated (as by solenoid 340), the knife sharpen signal could cause sharpening to take place automatically, without requiring operator input. For example, the controller 402 could automatically initiate sharpening after the slicing stroke count reaches the given number, provided the slicer is not in use (e.g., after the slicer knife and carriage have been stopped for a set time period). Alternatively, the operator may be required to trigger automated sharpening via actuation of the user input 412, which could simultaneously serve to reset the count.

In one implementation of the slicing stroke counting technique, the slicing strokes are only counted when the knife is running (e.g., as determined by the motor 406 being energized or based upon the feedback from encoder 414 or sensor 416). In another implementation of the slicing stroke counting technique, the slicing strokes are only counted when the knife is running and when a load on the knife driver exceeds a threshold level (e.g., as determined by the feedback from load sensor 420). In yet another implementation of the slicing stroke counting technique, multiple slicing stroke counts can be tracked according to food product sliced. An algorithm may be used to evaluate the multiple counts in a cumulative manner, with the algorithm taking into account the impact the type of food product has on dulling of the knife (e.g., it takes less slicing strokes of cheese to dull the knife when compared to turkey slicing strokes). In the latter implementation, the user input 412 can be utilized by the operator to input the type of food product being sliced (as by entering a product look-up (PLU) number). Alternatively, the slicer may include RFID capabilities as described in the PCT application published under International Publication No. WO 2005/004071 A1, by which the slicer can automatically determine the product being sliced based upon a sensed RFID tag of the food product.

In another technique, the controller 402 may count rotations of the slicer knife 14 (as determined by feedback from encoder 414 and/or sensor 416, or as determined by assuming a certain running speed for the knife, tracking knife on time and calculating knife rotations) in order to determine when to sharpen the knife. Specifically, based upon knife testing it can be determined that, on average, a slicer knife needs to be sharpened after a given number of knife rotations takes place. The controller tracks the count of knife rotations and when the count exceeds the given number, the controller outputs the knife sharpen signal. In one implementation of the knife rotation counting technique, knife rotations are only counted when a load on the knife driver exceeds a threshold level (e.g., as determined by the feedback from load sensor 420). In another implementation of the knife rotation counting technique, knife rotations are only counted when the food product carriage is moving (as determined by the feedback from sensor 418 or by energization of motor 408; where sensor 418 is an end of stroke sensor switch, the carriage may be considered to be “moving” (as that term is used herein) provided the sensor 418 is repeatedly tripped within a set time period, such as being tripped every 3-6 seconds for example).

In yet another technique, the controller 402 may count the running time of the slicer knife (as determined by the knife motor 406 being energized or ad determined by feedback from encoder 414 and/or sensor 416) in order to determine when to sharpen the knife. Specifically, based upon knife testing it can be determined that, on average, a slicer knife needs to be sharpened after running for a certain period of time. The controller tracks a time count corresponding to knife running time and when the count exceeds the given number, the controller outputs the knife sharpen signal. In one implementation of the knife running time counting technique, the run time is only counted when the food product carriage is moving (as determined by feedback from sensor 418 or by energization of motor 408).

In determining whether the count for the selected knife use characteristic exceeds a set count, the count could be a count up from zero to the set count (in which case count reset is back to zero) or the count could be a count down from the set count to zero (in which case count reset is back to the set count).

In tracking the count of the selected knife use characteristic, in one embodiment the controller may actually maintain a digital count value in memory, with the value being incremented or decremented as the case may be. Other types of digital counter implementations could also be used. In another embodiment the controller may include an analogue counter, such as one in which voltage pulses (e.g., one pulse corresponding to one count) are input to an integrator. When the voltage output of the integrator reaches a specific voltage, the set count is considered to be reached Other types of analogue counters could also be used. Accordingly, as used herein, it is not necessary for a digital number to be stored and incremented/decremented in order for an apparatus to fall within the scope of the meaning of the term “track a count” or “tracking a count” as used in the claims.

It is to be clearly understood that the above description is intended by way of illustration and example only, is not intended to be taken by way of limitation, and that other changes and modifications are possible.

What is claimed is:

1. A slicer for use in slicing a food product, the slicer comprising:
a slicer body;
a slicer knife mounted for rotation relative to the slicer body, the slicer knife having a peripheral cutting edge;
a food product carriage mounted to the slicer body for reciprocating movement back and forth past a cutting zone of the slicer knife;
a control operable to track a count of a selected knife use characteristic of the slicer, the control operable to effect production of a knife sharpen signal based at least in part upon the count.

2. The slicer of claim 1 wherein the selected knife use characteristic comprises slicing strokes of the food product carriage.

3. The slicer of claim 2 wherein the selected knife use characteristic comprises only slicing strokes of the food product carriage that occur while the slicer knife is running.

4. The slicer of claim 3 wherein the selected knife use characteristic comprises only slicing strokes of the food product carriage that occur while a load on a drive of the slicer knife exceeds a threshold level.

5. The slicer of claim 2 wherein the selected knife use characteristic comprises slicing strokes of the food product carriage, wherein at least some of the slicing strokes are associated with specific food products.

6. The slicer of claim 1 wherein the selected knife use characteristic comprises rotations of the slicer knife.

7. The slicer of claim 6 wherein the selected knife use characteristic comprises only rotations of the slicer knife that occur while a load on a drive of the slicer knife exceeds a threshold level.

8. The slicer of claim 6 wherein the selected knife use characteristic comprises only rotations of the slicer knife that occur while the food product carriage is moving.

9. The slicer of claim 1 wherein the selected knife use characteristic comprises run time of the slicer knife, the count comprises a time count.

10. The slicer of claim 9 wherein the selected knife use characteristic comprises only run time of the slicer knife while the food product carriage is moving.

11. The slicer of claim 1 wherein the knife sharpen signal is output responsive to the count exceeding a set count.

12. The slicer of claim 11 wherein the count is resettable via a user input device.

13. The slicer of claim 12 wherein the user input device comprises a sharpen initiate trigger, the slicer includes a sharpener assembly mounted to the slicer body, the sharpener assembly includes an associated powered actuator for moving a sharpening member into contact with the peripheral cutting edge of the knife in response to the sharpen initiate trigger.

14. The slicer of claim 11 wherein the knife sharpen signal effects operation of a visual indicator of the slicer.

15. The slicer of claim 11 wherein the knife sharpen signal effects operation of an audible indicator of the slicer.

16. The slicer of claim 1 wherein the control includes at least one of a digital counter and an analog counter for tracking the count.

17. A method for identifying when to sharpen a circular slicer knife of a slicer having a food product carriage mounted for reciprocating movement back and forth past a cutting zone of the slicer knife, the method comprising the steps of:
tracking a count of a selected knife use characteristic of the slicer;
comparing the tracked count with a set count; and
producing a knife sharpen signal based at least in part upon the comparison.

18. The method of claim 17 wherein the selected knife use characteristic comprises slicing strokes of the food product carriage while the slicer knife is running.

19. The method of claim 17 wherein the selected knife use characteristic comprises rotations of the slicer knife while the food product carriage is moving.

20. The method of claim 17 wherein the selected knife use characteristic comprises run time of the slicer knife while the food product carriage is moving, the count comprises a time count.

21. A slicer for use in slicing a food product, the slicer comprising:
a slicer body;
a slicer knife mounted for rotation relative to the slicer body, the slicer knife having a peripheral cutting edge;
a sharpener assembly mounted in an operating position on the slicer body and having a sharpening member movable between a standby position and a sharpening position, a powered actuator positioned for moving the sharpening member from the standby position to the sharpening position.

22. The slicer of claim 21 wherein the powered actuator comprises a solenoid.

23. The slicer of claim 21 wherein the slicer includes a switch for initiating operation of the powered actuator.

24. The slicer of claim 21 where in the slicer includes a control operable to effect operation of the powered actuator for a certain time period corresponding to a predetermined appropriate time period for sharpening the slicer knife.

25. A slicer for use in slicing a food product, the slicer comprising:
a slicer body;
a slicer knife mounted for rotation relative to the slicer body, the slicer knife having a peripheral cutting edge;
a sharpener assembly mounted in an operating position on the slicer body and having a sharpening member movable between a standby position and a sharpening position, an actuator positioned for moving the sharpening member from the standby position to the sharpening position;
wherein a control is provided to cause the sharpening member to move from the sharpening position to the standby position after a certain time period.

26. The slicer of claim 25 wherein the actuator is a powered actuator and the control is electronic.

27. The slicer of claim 25 wherein the actuator is manually operated and the control is a mechanical control incorporated into the sharpener assembly.
